(19) United States
(12) Patent Application Publication
(10) Pub. No.: US 2021/0136312 A1
(43) Pub. Date: May 6, 2021

(54) MULTI-FUNCTION REMOTE CONTROL

(71) Applicant: MU-CHEN TAMI, Taichung City (TW)

(72) Inventor: MU-CHEN TAMI, Taichung City (TW)

(21) Appl. No.: 16/672,199

(22) Filed: Nov. 1, 2019

(51) Int. Cl. H04N 5/44; G08C 17/02

(52) U.S. Cl. CPC H04N 5/4403; G08C 17/02; H04N 2005/4439; H04N 2005/4412; G08C 2201/20

(57) ABSTRACT

A multi-function remote control contains a first learning unit including a learning button and multiple blank buttons. The first learning unit includes a radio frequency (RF) module, an infrared radiation (IR) module, and an integration chip. The RF module includes a first emitter element configured to send RF signals and a first receiver element configured to receive the RF signals from a first electrical remote control and to send the RF signals to the integration chip via at least one pin. The IR module includes a second emitter element configured to send first infrared signals, and the IR module includes a second receiver element configured to receive the first infrared signals. The second receiver element is also configured to receive second infrared signals from a second electrical remote control and to send the second infrared signals to the integration chip via the at least one pin.

### FIELD OF THE INVENTION

The present invention relates to a multi-function remote control which is applied to integrate functions of buttons of at least one electrical remote control of at least one electrical equipment and remote control functions of a network control system.

### BACKGROUND OF THE INVENTION

Referring to FIG. 7, a conventional learning remote control 1 contains: a casing 10, a processing module, a storage module, a button control module 13, a signal receiving module 14, a signal transmitting module 15, and a display module 16.

The signal receiving module 14 and the signal transmitting module 15 are any one of infrared ray, radio frequency, and Bluetooth. The storage module 12 includes control data of remote control of all electrical equipment saved therein. When pressing at least one learning button 131 of the button control module 13 and a button (such as a power button) of the remote control, the remote control transmits the control signal of the remote control to the signal receiving module 14 of the learning remote control 1, and the control buttons (such as a power button 132, an increase button 133, a decrease button 134) of the button control module 13 of the learning remote control 1 are set to the button of the remote control of the all electrical equipment. However, the learning remote control only has a frequency wireless signal, so it cannot be applicable for other RF or IR remote controls.

In addition, a smart phone is used to remote control a door to open or close via Internet of Things. However, it is troublesome to enter an image of a control button of the small phone.

The present invention has arisen to mitigate and/or obviate the afore-described disadvantages.

### SUMMARY OF THE INVENTION

The primary aspect of the present invention is to provide a multi-function remote control which is applied to integrate functions of buttons of at least one electrical remote control of at least one electrical equipment and remote control functions of a network control system, wherein the at least one electrical equipment is any one of an air conditioner, a television (TV), a ceiling fan, a shutter door, an audio device, a lamp, and machinery or equipment for an industrial and agricultural field.

A multi-function remote control provided by the present invention contains: a first learning unit including a learning button and multiple blank buttons.

The first learning unit includes a radio frequency (RF) module, an infrared radiation (IR) module, and an integration chip, the RF module includes a first emitter element configured to send RF signals, a first receiver element configured to receive the RF signals from a first electrical remote control and to send the RF signals to the integration chip via at least one pin so that the RF signals are distinguished and saved; the IR module includes a second emitter element configured to send first infrared signals, and the IR module includes a second receiver element configured to receive the first infrared signals, wherein the second receiver element is also configured to receive second infrared signals from a second electrical remote control and to send the second infrared signals to the integration chip via the at least one pin.

The learning button and any one of the multiple blank buttons are pressed, the first receiver element receives the RF signals from the first electrical remote control and the second receiver element receives the second infrared signals from the second electrical remote control, such that the RF signals and the second infrared signals are sensed, wherein internal codes of a control frequency of the first electrical remote control are copied to the integration chip of the multi-function remote control.

### BRIEF DESCRIPTION OF THE DRAWINGS

FIG. 1 is a side plan view showing the assembly of multi-function remote control according to a preferred embodiment of the present invention.

FIG. 2 is a side plane view showing the assembly of a part of the multi-function remote control according to the preferred embodiment of the present invention.

FIG. 3 is a side plan view showing the operation of the multi-function remote control according to the preferred embodiment of the present invention.

FIG. 4 is another side plan view showing the operation of the multi-function remote control according to the preferred embodiment of the present invention.

FIG. 5 is also another side plan view showing the operation of the multi-function remote control according to the preferred embodiment of the present invention.

FIG. 6 is still another side plan view showing the operation of the multi-function remote control according to the preferred embodiment of the present invention.

FIG. 7 is a conventional side plan view of a conventional learning remote control.

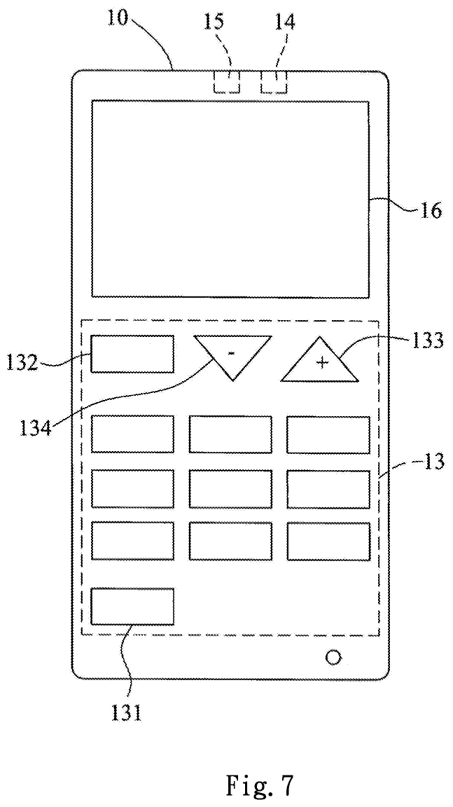

### DETAILED DESCRIPTION OF THE PREFERRED EMBODIMENTS

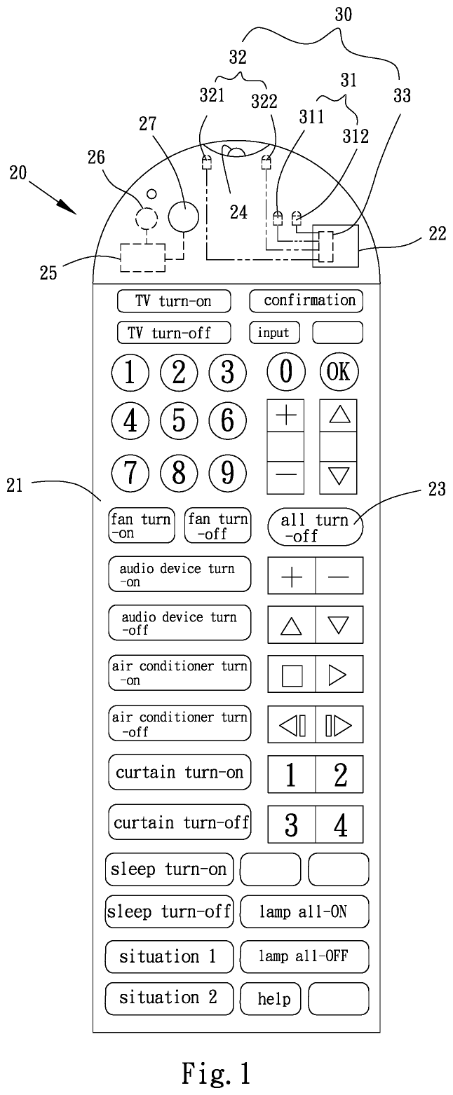

With reference to FIGS. 1-6, a multi-function remote control 20 according to a preferred embodiment of the present invention is applied to integrate functions of buttons of at least one electrical remote control 50 of at least one electrical equipment 40 and remote control functions of a network control system 60, wherein the at least one electrical equipment 40 is any one of an air conditioner, a television (TV), a ceiling fan, a shutter door, an audio device, a lamp, and machinery or equipment for an industrial and agricultural field.

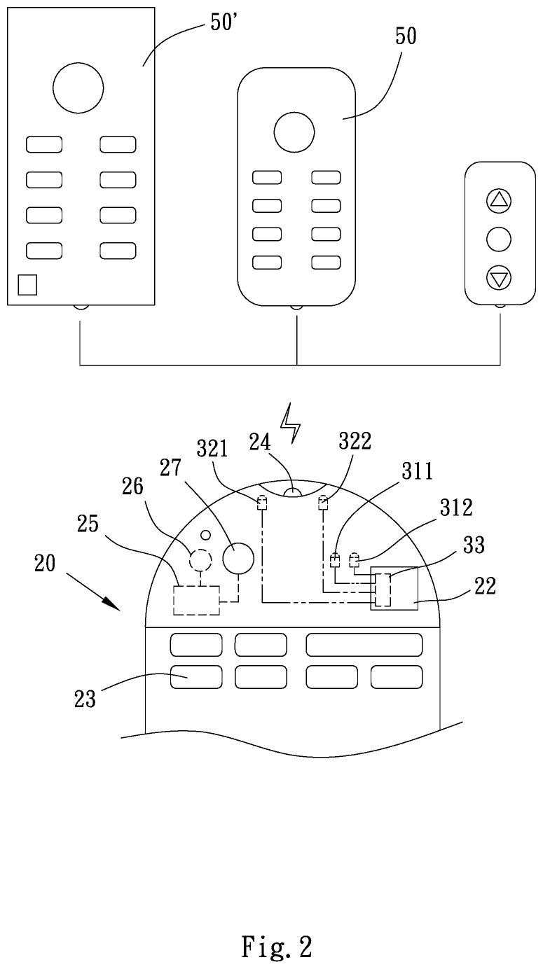

Referring to FIGS. 1 and 2, the multi-function remote control 20 comprises a casing 21, a learning button 22, multiple blank buttons 23, and a first learning unit 30. The learning button 22 is pressed to start the first learning unit 30, and the multiple blank buttons 23 includes multiple preset buttons, such a TV turn-on button, a TV turn-off button, an input button, a confirmation button, multiple number buttons (such as a “0” button, a “1” button, a “2” button, . . . , a “9” button), a channel adjustment button, a volume adjustment button, an audio device turn-on button, an audio device turn-off button, a fan turn-on button, a fan turn-off button, a sleep turn-on button, a sleep turn-off button, an all turn-off button, an air conditioner turn-on button, an conditioner turn-off button, a curtain turn-on button, a curtain turn-off button, a lamp all-ON button, a lamp all-OFF button, a situation 1 button, a situation 2 button, and a help button. The multi-function remote control 20 further comprises a light bulb 24 mounted on a front end of the multi-function remote control 20 so as to illuminate lights in a night.

The first learning unit 30 includes a radio frequency (RF) module 31, an infrared radiation (IR) module 32, and an integration chip 33. The RF module 31 includes a first emitter element 311 configured to send RF signals, a first receiver element 312 configured to receive the RF signals from a first electrical remote control 50 and to send the RF signals to the integration chip 33 via at least one pin so that the RF signals are distinguished and saved. The IR module 32 includes a second emitter element 321 configured to send first infrared signals, and the IR module 32 includes a second receiver element 322 configured to receive the first infrared signals, wherein the second receiver element 322 is also configured to receive second infrared signals from a second electrical remote control 50′ and to send the second infrared signals to the integration chip 33 via the at least one pin so that the second infrared signals are distinguished and saved.

In operation, a controlling button of the first electrical remote control 50 is pressed, and the learning button 22 and any one of the multiple blank buttons 23 are pressed so that the first receiver element 312 receives the RF signals from the first electrical remote control 50 and the second receiver element 322 receives the second infrared signals from the second electrical remote control 50′, such that the RF signals and the second infrared signals are sensed, wherein internal codes of a control frequency of the first electrical remote control 50 are copied to the integration chip 33 of the multi-function remote control 20.

The network control system 60 includes a host 61, a WiFi server 62, at least one controller 63, 63′ and a network remote control 64′.

The host 61 is a notebook computer or a tablet computer, and the host 61 includes a control program 611 and controls the at least one electrical equipment 40 via the at least one controller 63, 63′, wherein the at least one electrical equipment 40 is set to turn on or to turn off. Alternatively, a part of the at least one electrical equipment 40 is set to turn on and to turn off by editing the control program 611.

The WiFi server 62 is configured to send control signals between the host 61 and the at least one controller 63, 63′.

The at least one controller 63, 63′ is connected with the at least one electrical equipment 40 in a wired manner or in a wireless manner, wherein each of the least one electrical equipment 40 includes a respective one electrical remote control 50, wherein turning-on, turning-off, and the internal codes of the control frequency of the first electrical remote control 50 are copied in the multiple blank buttons 23 by ways of the first learning unit 30 of the multi-function remote control 20. When any one of the buttons of the multi-function remote control 20 is pressed, the control signals are sent to the at least one controller 63, 63′ so that the at least one controller 63, 63′ sends triggered signals to the host 61 via the WiFi server 62, and the WiFi server 62 transmits the control signals to the at least one controller 63, 63′ based on a setting of the control program 611 to execute control commands.

The network remote control 64 includes multiple control buttons so as to control turning-on, turning-off, or other adjustment functions of the at least one electrical equipment 40 in a radio frequency (RF) manner or in an infrared radiation (IR) manner, wherein the multiple control buttons of the network remote control 64 have at least one all turn-off button 641 connected with an all turn-off function of the control program 611, when the network remote control 64 is turned on, the WiFi server 62 notifies the host 61 to start an all turning-off function so as to turn off the at least one electrical equipment 40. Functions of the at least one all turn-off button 641 are copied to an all turn-off button of the multi-function remote control 20 by using the first learning unit 30, and remote control functions of the at least one electrical equipment 40 and remote control functions of the network control system 60 are integrated in the multi-function remote control 20, thus operating the at least one electrical equipment 40 and the network control system 60 easily.

One of the at least one controller 63, 63′ is connected with the at least one electrical equipment 40 in a wireless manner, the one controller 63 has multiple connection portions 631 extending from an side thereof, wherein a respective one connection portion 631 is configured to connect with an end of an electric wire, and the other end of the respective one electric wire is connected with a respective one electrical equipment 40, whereon one or at least one connection portion 631 is electrically connected with a control box 632 via a signal wire, the control box 632 has a wireless transmission module 633 and at least one control contact 634, wherein a respective one control contact 634 is electrically connected with any one connection portion 631 of the one controller 63 so as to turn on/off all electrical equipment 40 or a part of the at least one electrical equipment 40, and the wireless transmission module 633 is controlled by the network remote control 64 to send all turn on/off or partial turn on/off instruction to the host 61 via the WiFi server 62.

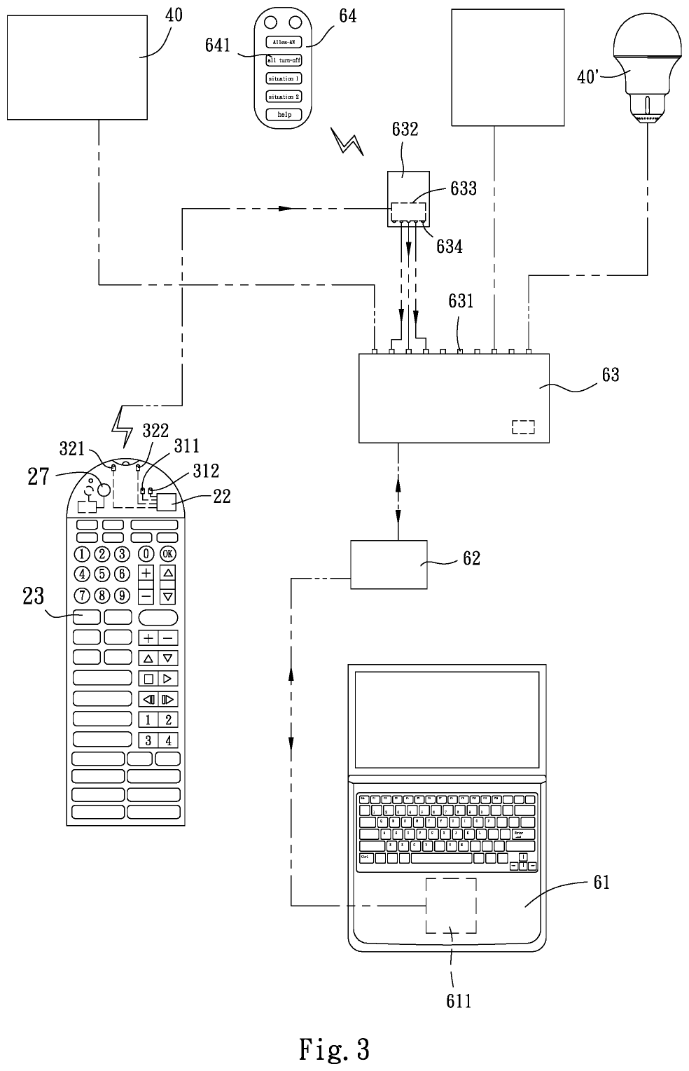

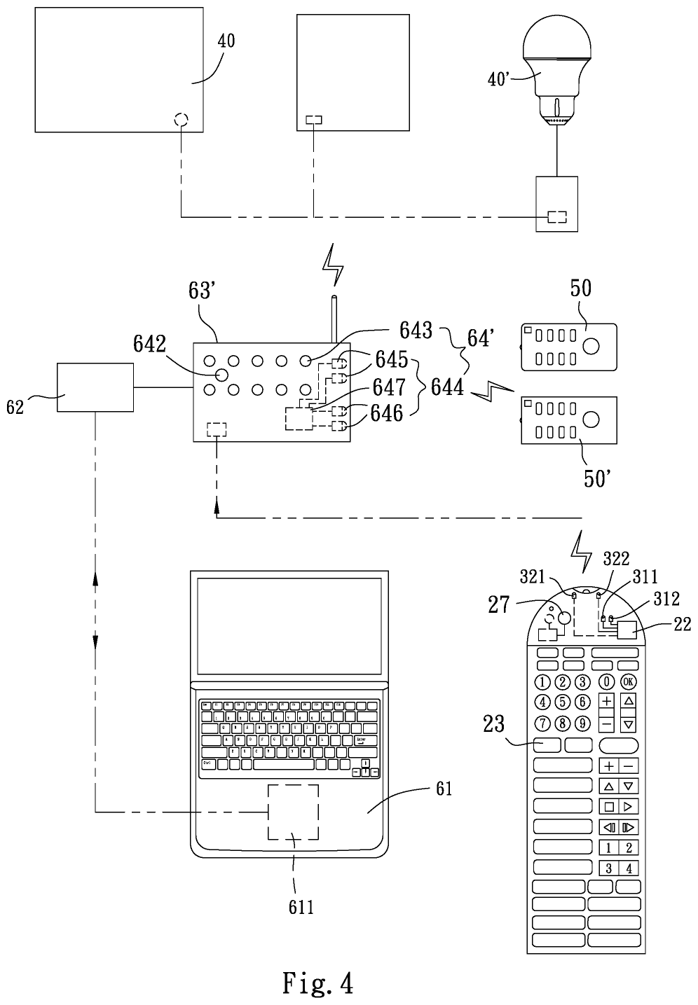

Referring to FIG. 4, the other controller 63′ is connected with the at least one electrical equipment 4 in a wireless manner, and the other controller 63′ is configured to send the control signals wirelessly. In application, the other controller 63′ sends the control signals to the at least one electrical equipment 40 (such as the TV, the air conditioner or the shutter door). For example, when the other controller 63′ sends the control signals to the lamp by using the control box 632 (as shown in FIG. 3), wherein the control box 632 has the wireless transmission module 633 built therein so as to receive the control signals wirelessly. A network remote control 64′ is mounted on the other controller 63′ and includes a learning button 642, multiple blank buttons 643, and a second learning unit 644. The second learning module 644 has a radio frequency (RF) module 645, an infrared radiation (IR) module 646, and an integration chip 67. The RF module 645 is configured to receive infrared radiation (RF) signals and to send the RF signals to the integration chip 67. The IR module 646 is configured to receive infrared radiation (IR) signals from a respective one of at least one electrical remote control 50′ and to send the IR signals to the integration chip 647.

When the network remote control 64′ copies internal codes of a control frequency of a button of the respective one electrical remote control 50′, the button of the respective one electrical remote control 50′ is pressed, and the learning button 642 and the blank button 643 are pressed so that the RF module 645 and the IR module 646 sense the RF signals and the IR signals respectively, and the RF module 645 or the IR module 646 copies the internal codes of the control frequency of the button of the respective one electrical remote control 50′ to the integration chip 647. Functions of the button of the at least one electrical equipment 40 are edited to the control program 611 of the host 61 by ways of the other controller 63′, thus setting all turn-on/turn off and partial turn on/off functions.

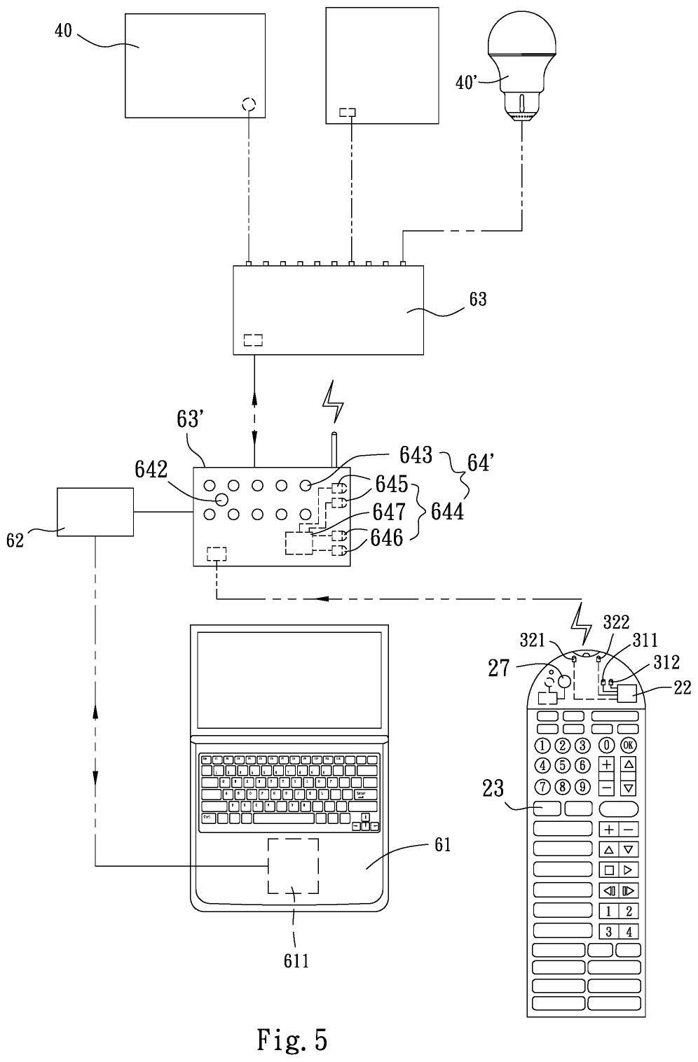

As shown in FIG. 5, the network control system 60 matches with a wired controller and a wireless controller 63′ so as to electrically connect the wired controller 63 and the wireless controller 63′. For example, after the multi-function remote control 20 sends an all turn/off signals to the wireless controller 63′, the WiFi server 62 sends a signal packet to the host 61, the control program 611 of the host 61 transmits an execution command to the wireless controller 63′, and the wireless controller 63′ sends the control signals to the at least one electrical equipment 40 which enables to receive the control signals wirelessly. The wired controller 63 sends the control signals to the lamp wiredly.

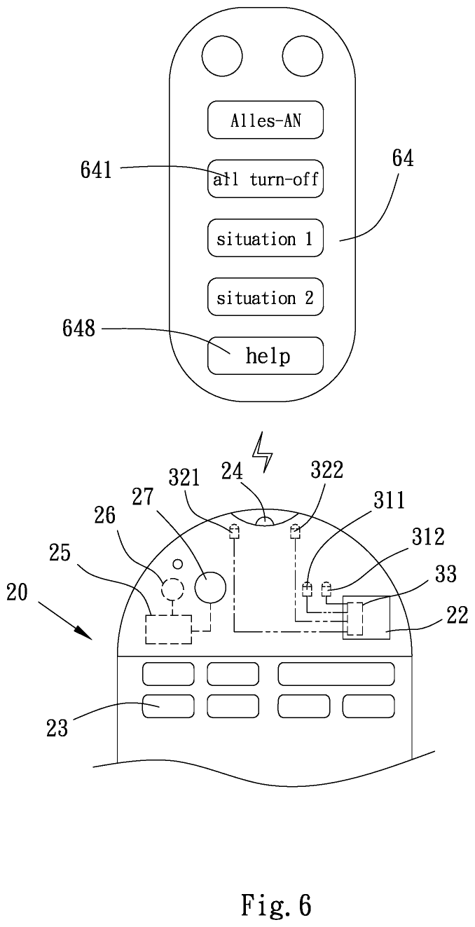

The multi-function remote control 20 matches with the network control system 60 to set the all turn-off buttons, the situation 1 button, the situation 2 button and the help button, wherein the all turn-off buttons and the control program 611 are connected with the all turn-off functions of the at least one electrical equipment 40. The situation 1 button, the situation 2 button, and the control program 611 are connected with the partial turn on/off function of a part of the at least one electrical equipment. When setting the help button, the network remote control 64 has a help sending button 648, and the control program 611 includes at least one help call setting. When the help sending button 648 is pressed, the control program 611 dials at least one help call to user's relatives and friends or a hospital, wherein the multi-function remote control 20 learns internal codes of a control frequency of the help sending button 648 (as shown in FIG. 6) so that the at least one help call setting of the control program 611 is connected with the help button of the multi-function remote control 20.

The multi-function remote control 20 further comprises a voice control integrated circuit (IC) 25 electrically connected with a microphone 26 and a voice control button 27. When pressing the voice control button 27 and any one function button (such as TV turn-on button) and speaks “turn-on the TV” to the microphone 26, the voice control IC 25 records the “turn-on the TV” and connects with the TV turn-on button. When the user is desired to turn on the TV by using voice control function, the voice control button 27 is pressed and the user speaks “turn-on the TV” to the microphone 26, thus turning on the TV.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

1. A multi-function remote control comprising
a first learning unit including a learning button and multiple blank buttons;
wherein the first learning unit includes a radio frequency (RF) module, an infrared radiation (IR) module, and an integration chip, the RF module includes a first emitter element configured to send RF signals, a first receiver element configured to receive the RF signals from a first electrical remote control and to send the RF signals to the integration chip via at least one pin so that the RF signals are distinguished and saved by the integration chip; the IR module includes a second emitter element configured to send first infrared signals, and the IR module includes a second receiver element configured to receive the first infrared signals, wherein the second receiver element is also configured to receive second infrared signals from a second electrical remote control and to send the second infrared signals to the integration chip via the at least one pin;
wherein when the learning button and any one of the multiple blank buttons are pressed, the first receiver element receives the RF signals from the first electrical remote control and the second receiver element receives the second infrared signals from the second electrical remote control, such that the RF signals and the second infrared signals are sensed, wherein internal codes of a control frequency of the first electrical remote control are copied to the integration chip of the multi-function remote control;
wherein the multi-function remote control further comprises a network control system including a host, a WiFi server, at least one controller and a network remote control, wherein the multiple blank buttons has an all turn-off button;
wherein the host includes a control program and controls the at least one electrical equipment via the at least one controller, wherein the at least one electrical equipment is set to turn on or to turn off or a part of the at least one electrical equipment is set to turn on and to turn off by editing the control program;
wherein the WiFi server is configured to send control signals between the host and the at least one controller;
wherein the at least one controller is connected with the at least one electrical equipment in a wired manner or in a wireless manner, wherein each of the least one electrical equipment includes a respective one electrical remote control, and turning-on, turning-off, and the internal codes of the control frequency of the first electrical remote control are copied in the multiple blank buttons by ways of the first learning unit of the multi-function remote control;
wherein when any one of the buttons of the multi-function remote control is pressed, the control signals are sent to the at least one controller so that the at least one controller sends triggered signals to the host via the WiFi server, and the WiFi server transmits the control signals to the at least one controller based on a setting of the control program to execute control commands;
wherein the network remote control includes multiple control buttons so as to control turning-on, turning-off, or other adjustment functions of the at least one electrical equipment in a radio frequency (RF) manner or in an infrared radiation (IR) manner, wherein the multiple control buttons of the network remote control have at least one all turn-off button connected with an all turn-off function of the control program, when the network remote control is turned on, the WiFi server notifies the host to start an all turning-off function so as to turn off the at least one electrical equipment; and functions of the at least one all turn-off button are copied to an all turn-off button of the multi-function remote control by using the first learning unit, and remote control functions of the at least one electrical equipment and remote control functions of the network control system are integrated in the multi-function remote control, thus operating the at least one electrical equipment and the network control system easily.

2. (canceled)

3. The multi-function remote control as claimed in claim 1, wherein one of the at least one controller has multiple connection portions extending from an side thereof, wherein a respective one connection portion is configured to connect with an end of an electric wire, and the other end of the respective one electric wire is connected with a respective one electrical equipment, whereon one or at least one connection portion is electrically connected with a control box via a signal wire, the control box has a wireless transmission module and at least one control contact, wherein a respective one control contact is electrically connected with any one connection portion of the one controller so as to turn on/off all electrical equipment or a part of the at least one electrical equipment, and the wireless transmission module is controlled by the network remote control to send all turn on/off or partial turn on/off instruction to the host via the WiFi server.

4. The multi-function remote control as claimed in claim 1, wherein the other controller is connected with the at least one electrical equipment in a wireless manner, and the other controller is configured to send the control signals wirelessly, the other controller sends the control signals to the at least one electrical equipment, wherein a network remote control is mounted on the other controller and includes a learning button, multiple blank buttons, and a second learning unit; the second learning module has a radio frequency (RF) module, an infrared radiation (IR) module, and an integration chip; the RF module is configured to receive infrared radiation (RF) signals and to send the RF signals to the integration chip; the IR module is configured to receive infrared radiation (IR) signals from a respective one of at least one electrical remote control and to send the IR signals to the integration chip; wherein when the network remote control copies internal codes of a control frequency of a button of the respective one electrical remote control, the button of the respective one electrical remote control is pressed, and the learning button and the blank button are pressed so that the RF module and the IR module sense the RF signals and the IR signals respectively, and the RF module or the IR module copies the internal codes of the control frequency of the button of the respective one electrical remote control to the integration chip, functions of the button of the at least one electrical equipment are edited to the control program of the host by ways of the other controller, thus setting all turn-on/turn off and partial turn on/off functions.

5. The multi-function remote control as claimed in claim 1, wherein the multi-function remote control matches with the network control system to set the all turn-off buttons, the situation 1 button, the situation 2 button and the help button, wherein the all turn-off buttons and the control program are connected with the all turn-off functions of the at least one electrical equipment; the situation 1 button, the situation 2 button, and the control program are connected with the partial turn on/off function of a part of the at least one electrical equipment; when setting the help button, the network remote control has a help sending button, and the control program includes at least one help call setting; when the help sending button is pressed, the control program dials at least one help call, wherein the multi-function remote control learns internal codes of a control frequency of the help sending button so that the at least one help call setting of the control program is connected with the help button of the multi-function remote control.
